(19) United States
(12) Patent Application Publication
(10) Pub. No.: US 2022/0154883 A1
(43) Pub. Date: May 19, 2022

(54) Fluid Transfer Apparatus

(71) Applicant: Kiinja Corporation, Fort Collins, CO (US)

(72) Inventors: Gregory A. Jackson, Livermore, CO (US); Michael D. Hake, Greeley, CO (US); Michael S. Harris, Livermore, CO (US); Kohl N. Jacobson, Fort Collins, CO (US)

(73) Assignee: Kiinja Corporation, Fort Collins, CO (US)

(21) Appl. No.: 17/522,630

(22) Filed: Nov. 9, 2021

Related U.S. Application Data
(60) Provisional application No. 63/114,780, filed on Nov. 17, 2020.

(51) Int. Cl. F17C 6/00; F17C 13/04

(52) U.S. Cl. CPC F17C 6/00; F17C 13/04; F17C 2221/013; F17C 2205/037; F17C 2225/0153; F17C 2250/043; F17C 2205/0335; F17C 2227/04; F17C 2227/0302; F17C 2205/0332

(57) ABSTRACT

A fluid transfer apparatus transfers fluid from a first bulk storage vessel at a gas pressure equal to or greater than a first gas pressure. The fluid transfers to a first or second supply vessel; each having a gas pressure equal to or less than a second pressure. The second pressure less than the first pressure. The fluid transfer continues until the fluid in the first or second supply vessel reaches a predetermined weight inside the first or second supply vessel. The fluid in the filled first or second supply vessel, at the predetermined weight, under a pressure equal to or less than the second pressure; and the fluid in a liquefied and gas state. The apparatus heats the fluid in the first or second supply vessel, filled to the predetermined weight, to bring the fluid in the first or second supply vessel to a third gas pressure. The third gas pressure higher than the first gas pressure and the second gas pressure. The fluid in the first or second supply vessel having the third gas pressure can include fluid in the liquefied gas state and gas state or super critical state.

### I. FIELD OF THE INVENTION

The present disclosure concerns a fluid transfer apparatus that transfers fluid from a first bulk storage vessel at a gas pressure equal to or greater than a first gas pressure. The fluid transfers to a first or second supply vessel; each having a gas pressure equal to or less than a second pressure. The second pressure less than the first pressure.

### II. SUMMARY OF THE INVENTION

The invention of the present disclosure advantageously includes a method having the step of relieving a gas phase of a fluid from a first supply vessel to achieve a first gas pressure in the first supply vessel less than a gas pressure of a gas phase of the fluid in a bulk storage vessel. It further includes transferring said fluid from said bulk storage vessel to said first supply vessel based on a difference in the gas pressure of said fluid in said bulk storage vessel and said gas pressure of said fluid in said first supply vessel, said fluid transferred, residing in said tank in a liquefied gas state and a gas state. Another advantageous step includes venting the fluid transferred to the first supply vessel in a gas phase at least during some of the time while fluid transfers from the bulk storage vessel to the first supply vessel. Further step includes ceasing venting the fluid from said first supply vessel and isolating the bulk storage vessel from said first supply vessel. An additional step includes heating the fluid transferred to the first supply vessel to a second gas pressure higher than the pressure in said bulk storage vessel and said first gas pressure.

The invention further advantageously includes a fluid transfer apparatus including a first filling line having an entry port, control valve, and exit port; the first filling line delimiting a first filling line fluid pathway. A supply line configuration having an entry port, control valve, and exit port; the supply line configuration selected from a group of supply line configurations consisting of a gas supply line configuration having an entry port, control valve, and exit port; a liquefied gas supply line configuration having an entry port, control valve, and exit port; and combinations thereof. The apparatus further includes a first gas vent line having an entry port, control valve, and exit port, a filling state of operation, and a supply state of operation.

The apparatus in the filling state of operation has the first filling line connecting a bulk storage vessel to a first supply vessel. The fluid in the bulk storage vessel at a gas pressure greater than or equal to a first gas pressure. The fluid in the first supply vessel at a gas pressure less than or equal to a second gas pressure. The first gas pressure greater than the second pressure during a flow of fluid from the bulk storage vessel to the first supply vessel. The flowing fluid travels from the bulk storage vessel through the filling line entry port and through the filling line exit port and into the supply vessel until the fluid in the supply vessel reaches a predetermined weight in said supply vessel. The fluid flowed into the vessel residing in the vessel in a liquefied state and a gas state.

Fluid in the gas state, received in the supply vessel from the bulk storage vessel, flows from the supply vessel into a gas vent line through a gas vent line entry port. The fluid flows into the gas vent line as fluid flows from the bulk storage vessel to the first supply vessel. The filling line control valve and the gas vent line control valve both open during at least part of the time during the flowing of said fluid into the supply vessel from the bulk storage vessel. The supply line configuration control valve closed.

When the apparatus resides in the supply state of operation, the supply line configuration connects the first supply vessel to a downstream apparatus. The fluid in the first supply vessel, at the predetermined weight, heated to place the fluid in the first supply vessel at a third gas pressure greater than the first and second gas pressure. The supply line configuration control valve open. Both said filling line control valve and gas vent line control valve closed.

### III. BRIEF DESCRIPTION OF THE DRAWINGS

FIG. 1 discloses a schematic of a fluid transfer apparatus of embodying features of the present invention the schematic shows two supply vessels which can be considered either connected to the apparatus or a component of the apparatus.

FIG. 2 discloses an isometric view of the apparatus shown schematically in FIG. 1; for convenience and ease of display some of the valves and fluid lines shown in the schematic have been omitted.

FIG. 3 is a rear view of the apparatus shown in FIG. 2.

FIG. 4 is a top view of a supply vessel which corresponds to the two supply vessels shown in FIG. 3 exclusive of certain fluid line structure shown in FIG. 3.

FIG. 5 is a cross sectional view of the supply vessel shown in FIG. 4.

FIG. 6 is a closeup view of the coupling shown at the first end of the supply vessel in FIG. 5.

FIG. 7 is a schematic view of a gas capture and circulating apparatus which can be used to capture and circulate gas exiting from a gas exit of the fluid transfer device shown in FIG. 1.

FIG. 8 is a schematic view of a chiller apparatus which can be used to liquefy fluid discharged from the storage vessel in FIG. 1 so it reaches an exit of a filling line opening into the supply vessels as a liquefied gas.

### IV. DETAILED DESCRIPTION OF THE INVENTION

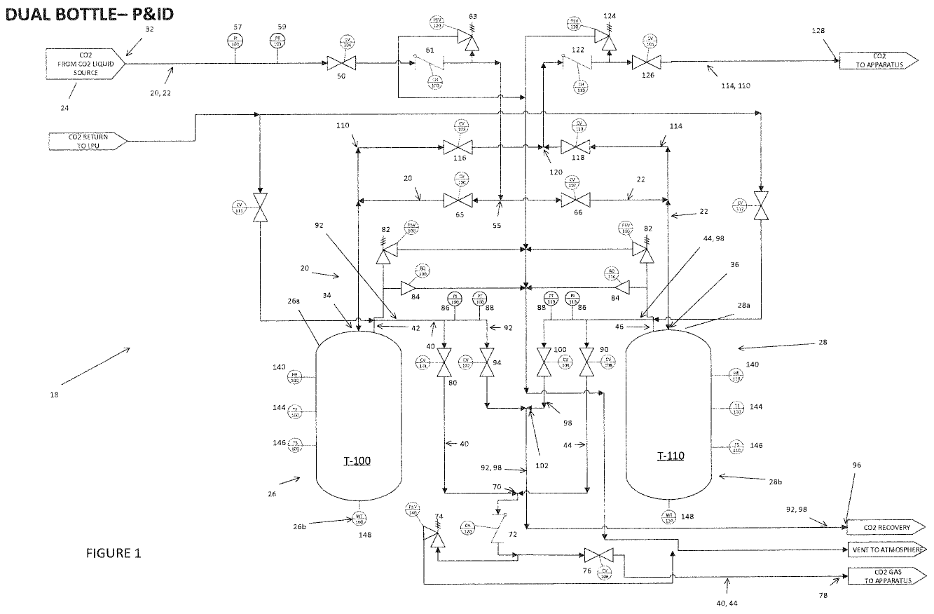

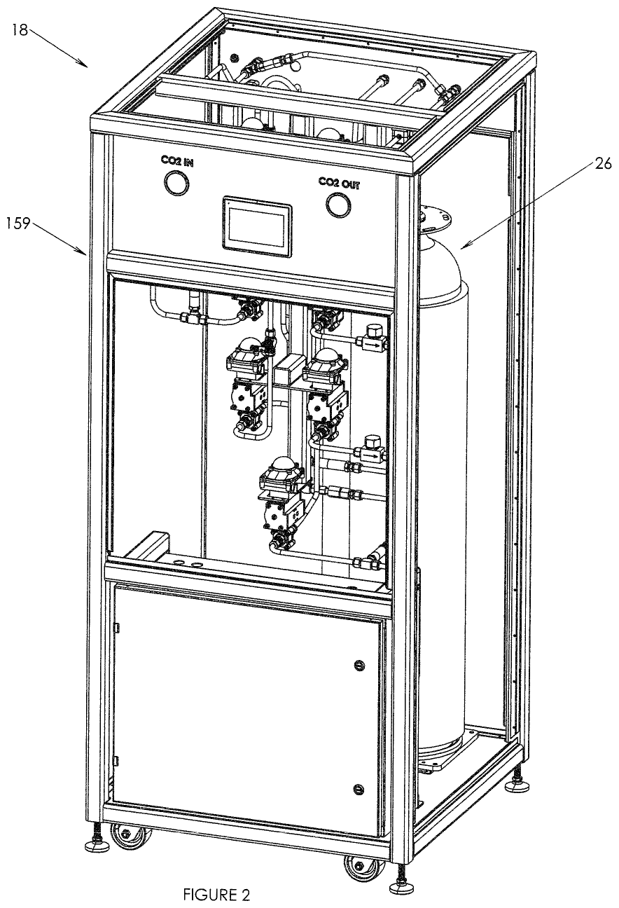

Now referring to FIGS. 1-4, a first fluid filling line (20) of and a second filling line (22) of the fluid transfer apparatus (18) connect a bulk storage vessel (24) a supply vessel (26, 28). The first supply line (20) connects the bulk storage vessel (24) to the first supply vessel (26), and the second supply line (28) connects the bulk storage to the second supply vessel (28). The bulk storage vessel (24) having fluid at a gas pressure no less than a first gas pressure. To fill the first supply vessel (26) or second supply vessel (28) with fluid from the bulk storage vessel (24), the apparatus (18) starts a blow down of the gas pressure in the first supply vessel (26) or second supply vessel. To initiate the blow down, the apparatus opens its first gas vent line control valve (94) or its second gas vent line control valve (100) which allows gas to exit the first supply vessel (26) or second supply vessel (28). From the first supply vessel (26), it enters the first gas vent line (92) through its entry port (42), travels along the first gas vent line (92) and exits the first gas vent line (92) through the gas vent exit (96). From the second supply vessel (28), it enters the second gas vent line (98) through its entry port (46), travels along the second gas vent line (98) and exits the second gas line at gas vent exit (96).

The blow down brings the gas pressure in the first supply vessel (26) or second supply vessel to a gas pressure no greater than a second pressure. The second pressure less than the first pressure. Once the apparatus (18) blows down the gas pressure in the first supply vessel or second supply vessel, fluid transfers from the bulk storage vessel (24) to the first supply vessel (26) or second supply vessel (28). The fluid transfers to the first supply vessel (26) through the first filling line (20). The fluid transfers to the second supply vessel (28) through the second filling line (22). The filling continues until the fluid in the first supply vessel (26) or second supply vessel (28) reaches a predetermined weight inside the first supply vessel (26). The fluid in the filled first supply vessel (26) or second supply vessel (28), at the predetermined weight, under a pressure no greater than the second pressure; and the fluid resides in the first supply vessel (26) or second supply vessel in a liquefied and gas state. The pressure in the bulk storage vessel remains at a gas pressure no less than the first gas pressure. Once the fluid reaches the predetermined weight, the apparatus closes its first gas vent control valve (94) or the second gas vent control valve (100) and its first filling line control valve (65) or its second filling line control valve (66). The apparatus (18) then heats the fluid in the first supply vessel (26) or second supply vessel (28), filled to the predetermined weight, to bring the fluid in the first supply vessel or second supply vessel to a third gas pressure. The third pressure higher than the first gas pressure and the second gas pressure. The fluid in the first supply vessel and second supply vessel (28) having the third gas pressure includes fluid in the liquefied gas state.

Once the fluid in the first supply vessel (26) or second supply vessel (28) reaches the third gas pressure, the apparatus opens, with respect to the first supply vessel (26), opens one or both of its first liquefied gas supply line control valves (116) and the first gas supply line control valve (80). Fluid from the first supply vessel (26), when the liquefied gas supply line control valve (116) resides in the open state, flows out the first supply vessel (26) and into a first liquefied gas supply line (110). The liquefied gas flows downstream through the first liquefied gas supply line (110) and to a downstream apparatus such as an extractor. Fluid from the first supply vessel (26), when the gas supply line control valve (80) resides in the open state, flows out the first supply vessel (26) and into a first gas supply line (40). The fluid in the gas state flows downstream through the first gas supply line (40) and to the downstream apparatus such as the extractor.

With respect to the second supply vessel (28), the apparatus opens one or both of its second liquefied gas supply line control valves (118) and the second gas supply line control valve (90). Fluid from the second supply vessel (28), when the second liquefied gas supply line control valve (118) resides in the open state, flows out the second supply vessel (28) and into a second liquefied gas supply line (114). The liquefied gas flows downstream through the first liquefied gas supply line (114) and to a downstream apparatus such as an extractor. Fluid from the second supply vessel (28), when the second gas supply line control valve (90) resides in the open state, flows out the second supply vessel (28) and into a second gas supply line (44). The fluid, in the gas state, flows downstream to the downstream apparatus.

As explained more fully below, the apparatus fills fluid into and supplies fluid from the second supply vessel (28) in seriatim with the first supply vessel (26). The expression filling line is broad enough to include filling conduit, and the expression filling conduit is broad enough to include filling line. One can use the terms interchangeably.

In more detail, the first filling line (20) extends from the first filling line entry port (32) to the first filling line exit port (34). The first filling line delimits a first filling line fluid pathway from the first filling line entry port (32) to the first filling line exit port (34). The structure that forms the first fluid filling line (20) includes all of the valves through or over which fluid passes when traveling downstream along the first filling line fluid pathway from the first filling line entry port (32) to the first filling line exit port (34). It also includes all valves which enable fluid along the first filling line fluid pathway to exit there through such as pressure relief valves.

The second filling line (22) extends from the second filling line entry port (32) to the second filling line exit port (36). The second filling line delimits a second filling line fluid pathway from the second filling line entry port (32) to the second filling line exit port (36). The structure that forms the second fluid filling line includes all of the valves through or over which fluid passes when flowing downstream along the first fluid filling path from the first filling line entry port to the first filling line exit port. It also includes all valves which enable fluid along the second filling line fluid pathway to exit though such as pressure relief valves.

The first filling line entry port (32) and second filling line entry port (32) can each include a coupling which delimits a through opening. Each opening delimits part of the first and second filling line fluid pathway through which fluid exiting the first bulk storage vessel (24) passes. The entry port (32) for each of the first and second filling lines can provide the first structure of the fluid transfer apparatus (18) through which the fluid exiting the first bulk storage vessel (24) passes on its way from the bulk storage vessel into its respective first supply vessel (26) and second supply vessel (28). In the present example, both the first filling line (20) and second filling line (22) share the same entry port (32). Thus, the first filling line entry port (32) and the second filling line entry port (32) share the same structure and coupling.

The exit port (34, 36) of each of the first (20) and second (22) filling lines can provide the last structure of the fluid transfer apparatus (18) through which the fluid exiting the bulk storage vessel (24) passes before entering into an internal void space delimited by an internal surface of its respective first (26) or second (28) supply vessel. The exit port (34, 36) for each first (20) and second (22) filling line each can include a coupling (34a, 36a) which delimits a the opening of the port (34, 36) through which respective fluid exiting the first (20) and second filling line (22) travels before entering within the respective internal void space delimited by the respective interior surface of the first (26) and second (28) supply vessel. The coupling (34a, 36a) forming the opening of the exit port (34; 36) can be a T coupling. Each T coupling forms another opening. Each other opening delimits another entry port (42, 46). The entry port (42) of the T coupling associated with the first supply vessel (26) forms an entry port (42) of a first gas supply line (40) and delimits a part of a first gas supply fluid pathway. The entry port (46) of the T coupling associated with the second supply vessel (28) forms an entry port (46) of a second gas supply line (44) and delimits a part of a second gas supply fluid pathway.

Now referring back to the first (20) and second (22) filling lines, each can include an extension (35, 37) which extends the first and second filling lines deep into their respective first (26) and second (28) supply vessel interiors as measured along the major axis of each supply vessel. The major axis extending along a first length of each of the first (26) and second (28) supply vessels measured from each supply vessels first end (26a, 28a) to each's second opposite end (26b, 28b). The first (26) and second (28) supply vessels have a minor axis perpendicular to the major axis. The minor axis of each extends along a second length measured from a first side to a second opposite side of each first and second supply vessel. The first and second sides can be opposite sections of an annular and circumferential sidewall of the first and second supply vessels. The extension (35, 37) of each first (20) and second (22) filling lines extends at least halfway of each vessel's first length towards each vessel's second end (26b, 28b). Each extension (35, 37) can extend three quarters of the length. Each can further extend to reside proximate each vessel's second end (26b, 28b). Each extension (35, 37) can be formed from a dip tube with an open end from which the fluid discharges into the interior of its respective vessel. The open end forms the exit port (34, 36). of the first (20) and second (22) filling lines.

Each first and second filling line, downstream of its respective entry port (32) and upstream of its exit port (34, 36) includes a first valve (50). In the present case the first valve is shared by the first and second filling line. The first valve can be a most upstream valve towards the entry port (32) of the first and second filling line. As stated, the first (20) and second (22) filling line share the same entry port (32). The shared valve can be a first safety valve (50). The first safety valve (50) can be an electronically actuated pneumatic valve or a solenoid valve. In general, the valve has an open and closed position.

A portion of the first and second filling line fluid pathways delimited by the first (20) and second (22) filling lines can be coextensive and can be delimited by and share the same filling line. In the present example the shared fluid pathway and shared line extends from the shared entry port (32), further extends to include the shared first safety valve (50), and further extends to a point where the shared fluid pathway and shared filling line branches off at a branch off point (55). The coextensive filling fluid pathway and filling line upstream of the safety valve fluidly connect to a pressure indicator (57) and pressure transmitter (59). Each item upstream of the first safety valve (50). The pressure indicator (57) is upstream of the pressure transmitter (59). The transmitter (59) can be electronically coupled to one or more processors. The pressure indicator can include to a visual dial. The pressure indictor and transmitter measure pressure upstream of the first safety valve (50). The coextensive portion also includes a check valve (61) downstream of the safety valve (50) and a pressure relief valve (63) downstream of the check valve (61).

The coextensive filling fluid pathway at the branch off point (55), branches in a first direction to form the first filling fluid pathway and first filling line (20) exclusive of the second filling fluid pathway and second filling line. The exclusive first filling fluid pathway and exclusive first filling line includes a control valve (65), the first filling line exit port (34), and first filling line extension (35). The shared fluid pathway also branches off in a second direction to form the second filling fluid pathway and second filling line (22) exclusive of the first filling line fluid pathway and first filling line (20). The exclusive second filling line fluid pathway and exclusive second filling line (22) includes a control valve (66), the second filling line exit port (36), and second filling line extension (37).

The fluid transfer apparatus includes the first gas supply line (40) having an entry port (42) formed from the T coupling. The first gas supply line (40) delimits a first gas supply fluid pathway. The T coupling forms an opening which delimits an entry port (42) of the first gas supply line (40). The T coupling is associated with the first supply vessel. A second gas supply line (44) delimits a second gas fluid pathway. The T coupling associated with the second supply vessel forms the entry port (46) of the second gas supply line (44) and delimits a part of the second gas supply fluid pathway.

A portion of each of the first gas supply fluid pathway and second gas supply fluid pathway delimited by the first (40) and second (44) gas supply lines can be coextensive and be delimited by and share the same gas supply line. The coextensive portion begins downstream of an intersection point (70) formed by the first (40) and second (42) gas supply lines intersecting. The shared same gas line extends from the intersection point (70) to and includes a check valve downstream of the intersection point. The shared line further downstream of the check valve (72) opens to a pressure relief valve (74). The shared gas supply line extends further downstream of the pressure relief valve (74) to a shared second safety valve (76). From the safety valve (76), the shared gas supply line extends to a shared gas exit port (78). The shared safety valve (76) can be considered a first gas supply line safety valve (76) and second gas supply line safety valve (76). The safety valve resides as the most downstream valve along the first (40) and second (42) gas supply lines relative to the gas exit port (78). The shared gas exit port (78) can be considered a gas exit port (78) of each of the first (40) and second (42) gas supply lines. The shared gas exit port (78) of the first and second gas supply line can comprise a coupling which forms the last structure through which gas exits from the fluid transfer apparatus (18) and the first and second gas supply lines before entering a fluid path of a downstream apparatus. The downstream apparatus can be a CBD extractor.

A portion of the first gas supply fluid pathway and first gas supply line (40) can be exclusive of the second gas supply pathway and the second supply line. The exclusive portion of the first gas supply line (40) includes the first supply gas entry port (42), and the T coupling at the first end (26a) of the first supply vessel (26) delimiting the port (42). It extends from the entry port (42) to and includes a control valve (80). It also includes a pressure relief valve (82) downstream of the first gas supply entry port and upstream of the control valve (80). It further includes a rupture disc (84) downstream of the entry port and upstream of the pressure relief valve. Upstream of the control valve (80) and downstream of the entry port (42), pressure relief valve (82), and rupture disc (84), the first supply gas line and pathway fluidly connect to a pressure indicator (86) and pressure transmitter (88). The pressure indicator (86) is upstream of the pressure transmitter (88). The transmitter can be electronically coupled to one or more processors. The pressure indicator (86) can include a visual dial. The pressure indictor and transmitter measure pressure upstream of the second safety valve (76) and the first gas supply control valve (80).

A portion of the second gas supply fluid pathway delimited by the second supply gas line (44) can be exclusive of the first gas supply fluid pathway and the first gas supply line (40). The exclusive portion of the second gas supply line (44) includes the second supply gas line entry port (46), and the T coupling at the first end (28a) of the second supply vessel (28) delimiting the entry port (46). It extends downstream from the entry port (46) to and includes a control valve (90). It also includes a pressure relief valve (82) downstream of the second gas supply entry port (46) and upstream of the control valve (90). It further includes a rupture disc (84) downstream of the entry port (46) and upstream of the pressure relief valve (82). Also, upstream of the control valve and downstream of the second gas entry port, pressure relief valve (82), and rupture disc (84), the line and pathway fluidly connect to a pressure indicator (86) and pressure transmitter (88). The pressure indicator (86) is upstream of the pressure transmitter (88). The transmitter can be electronically coupled to one or more processors. The pressure indicator (86) can include a visual dial. The pressure indictor (86) and transmitter (88) measure pressure upstream of the control valve (90) and the shared second safety valve (76). The pressure indictor and transmitter measure pressure upstream of the second safety valve (76) and the second gas supply control valve (90). The exclusive portions of the first and second gas supply lines and gas supply pathways intersect at the intersection point (70).

The fluid transfer apparatus (18) includes a first gas vent line (92) delimiting a first gas vent pathway. The first gas vent line has an entry port (42) formed from the T coupling. The T coupling delimits the entry port (42) of the first gas vent line (92). The first gas vent line and the first gas supply line share the same entry port (42) and T coupling structure which delimits the entry port (42). Additional portions of the first gas vent pathway and first gas supply pathway are coextensive and are delimited by the same line and share the same line structure. The coextensive portion extends from the entry port (42) downstream to but not including a control valve (94) for venting and blowing gas off from the first supply vessel (26). The coextensive portion includes the pressure relief valve (82) downstream of the first vent line entry port (42) and upstream of the control valve (94). It further includes the rupture disc (84) downstream of the entry port (42) and upstream of the pressure relief valve (82). Upstream of the control valve (94) for venting and downstream of the gas vent entry port (42), pressure relief valve (82), and rupture disc (84), the first gas vent line (92) and vent fluid pathway fluidly connect to the same pressure indicator (86) and pressure transmitter (88) as connected to by the first gas supply line (40). Downstream of the control valve (94) for venting, and the control valve (80) for supplying gas, the first gas vent line (92) and first gas supply line (44) share the same pressure relief valve (82). The first gas vent line extends downstream from the gas vent entry port (42) to the control valve (94) for venting, downstream from the control valve for venting to the gas exit gas. The first gas vent line (92), downstream of the control valve (94), intersects a second gas vent line (96) at a point of intersection (102).

The fluid transfer apparatus (18) includes the second gas vent line (96) delimiting a second gas vent fluid pathway. The second gas vent line (96) has an entry port (46) formed from the T coupling associated with the second supply vessel (28). The T coupling forms an opening which delimits the entry port (46) of the second gas vent line. The second gas vent line (98) and the second gas supply line (44) share the same entry port (46) and T coupling structure which delimits the entry port (46). Additional portions of the second gas vent fluid pathway and second gas supply fluid pathway are coextensive and are delimited by the same line and share the same line structure. The coextensive portions extend from the shared entry port (46) up to but not including a control valve (100) for venting and blowing gas off from the second supply vessel (28). The coextensive portion includes the pressure relief valve downstream of the second vent line entry port (46) and upstream of the control valve (100) for venting from the second supply vessel. It further includes the rupture disc downstream of the entry port and upstream of the pressure relief valve. Upstream of the control valve (100) for venting and downstream of the second gas vent entry port (46), pressure relief valve (82), and rupture disc (84), the second gas vent line (96) and second gas vent fluid pathway fluidly connect to the same pressure indicator (86) and pressure transmitter (88) as connected to by the second gas supply line (44). Downstream of the control valve (100) for venting from the second supply vessel (28), and the control valve (90) for supplying gas from the second supply vessel, the second gas vent line (98) and second gas supply line (44) share the same pressure relief valve (74). The second gas vent line (98) extends downstream from the second gas vent entry port (46) to the control valve (94) for venting, downstream from the control valve (100) to the gas exit vent (96). The second gas vent line (98), downstream of the control valve (100) for venting from the second supply vessel, intersects the first gas vent line (92) at a point of intersection (102).

Notably the first gas vent fluid line (92) and the second gas vent fluid line (98) starting from the point of intersection (102) and downstream therefrom are coextensive and delimited by and share the same gas vent supply line structure. The shared line extends from the point of intersection downstream to the gas vent exit (96) which can comprise a coupling. It includes therebetween the pressure relief valve (74).

The fluid transfer apparatus (18) includes a first liquefied gas supply line (110). The liquefied gas line delimits a first liquefied gas fluid pathway. A coupling at the first end of the first supply vessel delimits an opening. The coupling in the present example can be formed from the T coupling (34a). The first end of the extension (35) delimits a first liquefied gas entry port (34) of the first liquefied gas supply line. The entry port (34) of the liquefied gas supply line shares the same structure forming the first filling line exit port (34). The extension (35) extends through the opening delimited by the coupling (34a).

The fluid transfer apparatus also includes a second liquefied gas supply line (114). The second liquefied gas line (114) delimits a second liquefied gas fluid pathway. A coupling at the first end of the second supply vessel (28) delimits an opening. The coupling in the present example can be formed from the T coupling (36a). The extension (37) extends the second liquefied gas supply line (114) deep into the second vessel (28) interior as measured along the major axis of the second supply vessel. The first end of the extension delimits a second liquefied gas entry port (36) of the second liquefied gas supply line. The entry port shares the same structure as the second gas filling line exit port (36). The entry port (36) shares the extension (37) with the exit port (36) of the second gas filling line which extends through the opening delimited by the coupling.

A portion of the first liquefied gas supply line and first liquefied supply fluid pathway can be exclusive of the second liquefied gas fluid pathway and the second liquefied gas supply line. The exclusive portion of the first liquefied gas supply line includes the first liquefied gas entry port (34), it extends downstream from the entry port (34) through the coupling (34a) at the first end of the first supply vessel (26). It further extends to a control valve (116).

A portion of the second liquefied gas supply fluid pathway and supply line (114) can be exclusive of the first liquefied gas fluid pathway and first liquefied gas supply line. The exclusive portion of the second liquefied gas supply line (114) includes the second liquefied gas entry port (36), it extends downstream from the entry port (36) through the coupling (36a) at the first end of the second supply vessel (28a). It further extends to a control valve (118). The exclusive portion of the first liquefied gas supply line and the exclusive portion of the second liquefied gas supply line intersect at an intersection (120).

A portion of the first and second liquefied gas supply fluid pathways are coextensive with each other and delimited by and share the same liquefied gas supply filling line. The coextensive portion starts at the point of intersection (120) and extends downstream from the intersection. The coextensive shared line includes a check valve (122) downstream of the intersection; a pressure relief valve (124) downstream of the check valve (122); a third safety valve (126) downstream of the pressure relief valve; a liquefied gas exit port (128) downstream of the third safety valve. The third safety valve can be called a first liquefied gas supply line safety valve and a second liquefied gas supply line safety valve. The downstream, shared third safety valve (126) resides more downstream relative to the liquefied gas exit port than any other valve. The shared liquefied gas exit (128) can be considered a liquefied gas exit (128) of each of the first and second liquefied gas supply lines. The liquefied gas exit port of the first and second liquefied gas supply line comprises a coupling which forms the last structure through which liquefied gas exits from the fluid transfer apparatus (18) and the first (110) and second (114) liquefied gas supply lines before entering a fluid path of a downstream apparatus. The downstream apparatus can be the CBD extractor.

The expression supply line and vent line are broad enough to include supply conduit and vent conduit and the expression supply conduit and vent conduit is broad enough to include supply line and vent line. One can use the terms interchangeably. The structure that forms supply lines and vent lines discussed in this disclosure include all the valves through or over which fluid passes when traveling downstream along the lines' respective fluid path. It also includes all valves and structures which enable fluid along the respective fluid path to exit from the path such as pressure relief valves or rupture discs.

Notably all of the control valves and safety valves described herein can be electrically coupled to one or more processors and receive signals from the one or more processors to open and close depending on the occurrence or non-occurrence of certain events described more fully below.

The first supply vessel and second supply valve each have a heater (140) connected thereto. Each heater connects to an exterior surface of the vessel. Each heater heats its respective metal vessel which in turn heats the fluid inside the vessels. The fluid can be CO₂ in the liquid and gaseous state. Each heater has a plurality of heating elements which heat the metal. The heaters can be electrically connected to one or more processors and turned on and off by signals received from the processor. The heater could have a construction which directly heats the CO₂ instead of the vessel holding the CO₂. Each supply vessel can include a temperature element (144) which measures the temperature of the metal vessel as a proxy for the temperature of the fluid inside each vessel. It could alternatively directly measure the fluid inside the vessel such as CO₂. The temperature element can be electrically coupled to the one or more processors and transmit to the one or more processors. Each vessel can include a temperature switch (146). The switch can mechanically break a circuit to cut electrical supply to the heater if it detects heat exceeding a threshold. Each vessel can also include a weight sensor (148) which measures the weight of the fluid inside the vessel. The sensor can of course be calibrated to determine the weight of the fluid inside the device by measuring the vessel inclusive of the fluid inside the device. The weight sensor which can be an electronic scale coupled to the one or more processors and send signals to the one or more processors. The first and second supply vessels are standard off-the-shelf cylinders rated to carry 100 pounds of liquefied CO₂ with a gas head.

The fluid transfer apparatus has a first fluid supplying only state of operation. In the first supplying state of operation one of the two vessels is supplying the fluid in the vessel to the downstream apparatus. The fluid in the other of the two vessels is prevented from flowing out of the vessel by the transfer apparatus. The other vessel is neither discharging nor receiving fluid. The fluid supplied by the supplying vessel can be in the gas and/or liquefied state depending on the requirements of the downstream apparatus. In the present example, it is the first supply vessel (26) supplying the fluid and the first supply vessel (26) is supplying the fluid in only the liquefied gas state. Its supplying CO₂ under a gas pressure at a target pressure of 700 PSI. During supply, the first liquefied gas supply line (110) receives the liquefied gas through the liquefied gas line entry port (34). The liquefied gas travels along the first liquefied gas line (110) downstream and exits the apparatus at the liquefied gas exit port (128). The control valve (116) of the first liquefied gas line is open; the liquefied gas travels therethrough. The first gas supply line control valve (80) is closed. The vessel could of course supply only gas. In this case, the first gas supply line (40) receives the fluid in gas form through its gas entry port (42) under a target gas pressure of 700 PSI and exits the apparatus through the gas exit port (78). The control valve (65) of the first gas supply line (40) is open and the gas travels therethrough. The first liquefied gas supply line control valve (116) is closed. Of course, if the apparatus requires the fluid in the gas phase and liquid phase, the first gas and liquefied gas supply control valves (65, 116) would be both open.

During a fluid supplying only state, the control valve (94) of the first gas vent line (92) is closed. The control valve (65) of the first fluid filling line (20) is closed. Respecting the second vessel (28), the second filling line (22) control valve (66) is closed. The second gas vent line (98) is closed by way of vent control valve (100). Further the second liquefied gas supply line control valve (118) is closed, and the second gas supply line control valve (90) is closed. The fluid resides in the second vessel in a static state. The temperature element and the pressure transmitter can be transmitting signals to the one or more processors. The pressure transmitter can include the transmitter along the first gas vent line and first gas supply line; both open to the gas entry port. Based on the signals, the one or more processors can turn the heater on and off to maintain the CO₂ at a desired supply/operating pressure which can be a PSI high enough to satisfy the requirement of the downstream apparatus which can be a target pressure of 700 PSI.

As the first supply vessel supplies fluid to the apparatus, the weight of the fluid in the first supply vessel (26) falls. The weight sensor (148) transmits the current weight to the processor. When the weight decreases to a threshold level, set point, the apparatus ceases operating in the first fluid only supply state of operation. In the present example the set point weight can be a floor weight of 16 pounds. It changes over to a second state of operation, wherein the vessel supplying the fluid, in this case the first supply vessel (26), starts being filled with fluid from the bulk storage vessel (24) and the second supply vessel (28) starts supplying fluid to the downstream apparatus.

Respecting the portion of the apparatus' operation that fills the first supply vessel (26), both the first liquid gas supply line control valve (116) and first gas supply line control valve (80), if open, are automatically closed by way of signals from the one or more processors. The first gas vent line control valve (94) opens. The gas vents/discharges from the first supply vessel (26) along the pathway delimited by the first gas vent line (92) and travels downstream from the first gas vent line entry port (42) to the first gas vent line gas exit port (96). Once the pressure in the vessel decreases to a certain amount, the first filling line control valve opens. In the present example the threshold pressure, set point, to which the pressure decreases can be just below 200 PSI. The pressure in the first vessel is reduced by the venting gas from the supply vessel (26) to achieve a pressure in said first supply vessel below the pressure in the bulk storage vessel. In the present example the storage vessel has fluid, CO₂, in the gaseous and liquid state at a pressure of 250 PSI. The fluid in the gas state forms a gas head in the bulk storage vessel (24). As a result of the pressure differential, fluid, liquefied CO₂ gas, flows downstream from the bulk storage vessel (24) to the first supply vessel (26) along the first filling fluid pathway delimited by the first filling line (20). It enters the first filling line (20) through the first filling line entry port (32) and discharges into the first supply vessel (26) through the first filling line exit port (34). The pressure differential being a cause of the transfer. During the filling, the first vent line control valve (94) remains open. The continuous venting helps keep the fluid cool and in the liquefied state as the first supply vessel (26) fills with liquefied gas. The filling continues until the fluid in the first supply vessel (26) reaches a certain weight. When the weight is achieved the vessel (26) has the fluid in both the liquid and gaseous state. The fluid in the gaseous state forms a gas head. The CO₂ leaves the bulk storage vessel in the liquefied state and enters the first filling line (20) in the liquefied state. The fluid in the liquefied state discharges from the first filling line exit port (34) into the first supply vessel (26). Some of the liquefied gas in the supply vessel vaporizers. Once the fluid reaches the predetermined weight, as sensed by the weight sensor/detector, the first vent line control valve (94) closes and the first filling line control valve (65) closes. The predetermined weight in the present example is a fill weight of 100 pounds. The fluid resides in the vessel in the liquefied state with a gas head. Once the first supply vessel (26) obtains the predetermined fill weight and the valves close, the heater (140) turns on and heats the fluid in the first supply vessel (26) until the fluid in the vessel achieves a predetermined pressure higher than the pressure of the fluid in the bulk storage vessel and at a pressure high enough to satisfy the downstream apparatus' requirements. In the present example the pressure is a target pressure of 700 pounds, and the heat is applied to increase the temperature of the CO₂ to no more than 140° F. The target temperature to achieve is 55° F. to achieve 700 psi.

The fluid is at a pressure in the first supply vessel (26) to be delivered to the downstream apparatus under a high enough pressure to satisfy the requirements of the apparatus without requiring pumps to increase the pressure under which the fluid is delivered. Also, the fluid in the first supply vessel is pressurized from the blowdown pressure of just below 200 PSI to the predetermined target pressure of 700 PSI without requiring the use of pumps. By way of the apparatus, the first supply vessel (26) receives fluid from the bulk storage vessel (24). The pressure deferential, prior to heating, provides a basis for receipt of the fluid from the bulk storage vessel to the first supply vessel. The apparatus, uses heat as a basis, pressurize the fluid to be at a much higher pressure in the supply vessel (26) than in the bulk storage vessel (24); all without requiring the use of pumping apparatus. In the present example, once the fluid reaches the appropriate pressure, the first gas supply line and first liquefied gas supply line remains closed. The apparatus keeps the fluid from flowing out of the first supply vessel (26). The vessel (26) is neither receiving nor discharging fluid. The heater (140) can turn on and off to apply heat to the fluid in the first supply vessel (26) to maintain the desired target pressure of 700 PSI.

The fluid transfer apparatus to provide continuous supply of fluid in the gas and/or liquefied state, to the downstream apparatus, during the filling and pressurizing of the first supply vessel (26), starts supplying the fluid in the liquefied and or gas state to the downstream apparatus from the second supply vessel (28). The fluid is supplied in the same manner as the first supply vessel supplies fluid to the downstream apparatus. The second supply vessel (28), even after the first vessel becomes filled during the filling process and brought up to the desired pressure, continues to supply fluid to the downstream apparatus in the same manner as the first supply vessel. In summary, the second supply vessel (28) supplies fluid in the gaseous and or liquefied state through the second gas supply line (44) and/or the second liquefied gas supply line (114). To initiate the supply of gas, the apparatus' second gas supply line control valve (90) opens. The gas enters the second gas supply line through the second gas supply line entry port (46) and flows downstream through the control valve (90). The gas flows downstream from the control valve (90) and exits the second gas supply line (44) through the gas exit port (78). To initiate the supply of liquefied gas, the apparatus' second liquefied gas supply line control valve (118) opens. The liquefied gas enters the second liquefied gas line (114) through the liquefied gas line entry port (36) and flows downstream through control valve (118). The liquefied gas exits the liquefied gas line through the liquefied gas exit port (128). The apparatus (18) continues to prevent the first supply vessel (26) from receiving or discharging fluid. The heater can turn on and off to maintain the fluid in the first supply vessel (26) at the desired pressure.

Once the weight of the fluid in the second supply vessel (28) declines to a threshold weight, set point, the apparatus begins the filling process of the second vessel. In the present example the threshold weight is the floor weight of 16 pounds. The filling process is the same as the process used to fill the first supply vessel (26). Of course, the process of filing the second supply vessel uses the second filling line (22), the second gas vent line (98), and the heater (140) associated with the second supply vessel. Liquefied gas flows from the bulk storage vessel (24) into the second filling line (22) through the lines' entry port (32). The pressure in the second supply vessel is blown down to a pressure of just below 200 psi by opening the second gas vent control valve. Once the bow down pressure is reached, to initiate the flow, the second filling lines' control valve (66) is opened. The liquefied gas flows downstream from the entry port (32), through the control valve (66) and into the second supply vessel (28) through the second filling line exit port (36). Once the second supply vessel reaches a fill weight of 100 pounds the second gas vent line control valve (100) closes and the second filling line control valve (66) closes. The heater (140) is turned on and heats the fluid in the vessel until it reaches the desired pressure of 700 PSI. The second liquefied gas supply line control valve (118) and second gas supply line control valve (90) remain closed. During the filling process of the second supply vessel (28), the apparatus brings the first supply vessel (26) online and starts supplying fluid from the first supply vessel (26) to the downstream apparatus as explained above. The supplying continues after the second supply vessel (28) becomes filled and continues until the fluid in the first supply vessel (26) declines again to the setpoint weight of a floor weight of 16 pounds. The apparatus (18) than initiates the operation to fill the first supply vessel (26) and supply fluid from the second supply vessel (28) to the downstream apparatus as explained above.

Of course, the apparatus has a state of operation where the apparatus is filling the first and/or second supply vessel without supplying gas/liquefied gas to the downstream apparatus. This filling only state can include the heating operation to bring the fluid in the first and/or second supply vessel to the desired pressure.

In the present example the fluid enters the first and second filling line entry port from the bulk storage vessel in the liquefied state. The bulk storage vessel holds the fluid in the liquid state with a gas head. It is possible the bulk storage vessel can release fluid in the gaseous state but be delivered to the supply vessel in the liquefied state. In this case, the gas needs to be chilled to liquefy before delivery to the supply vessel (26; 28). A chiller can chill the gas before delivery to the apparatus or the chiller can be integrated as part of the apparatus to liquefy the gas before delivery to the supply vessel. FIG. 8 shows the application of the of a chiller (200) upstream of the fluid transfer apparatus (18). In operation the chiller receives fluid in the gaseous state from the bulk storage vessel (24). The gas enters the chiller through entry port (206). The gas passes through heat exchanger (204) and liquefies before exiting the chiller (200) at exit port (207). The chiller maintains the cold temperature of the fluid circulating through heat exchanger (204) by way of chiller package unit (202). The use of a chiller means the bulk storage vessel (24) can hold the fluid, such as CO₂, exclusively in the gaseous state.

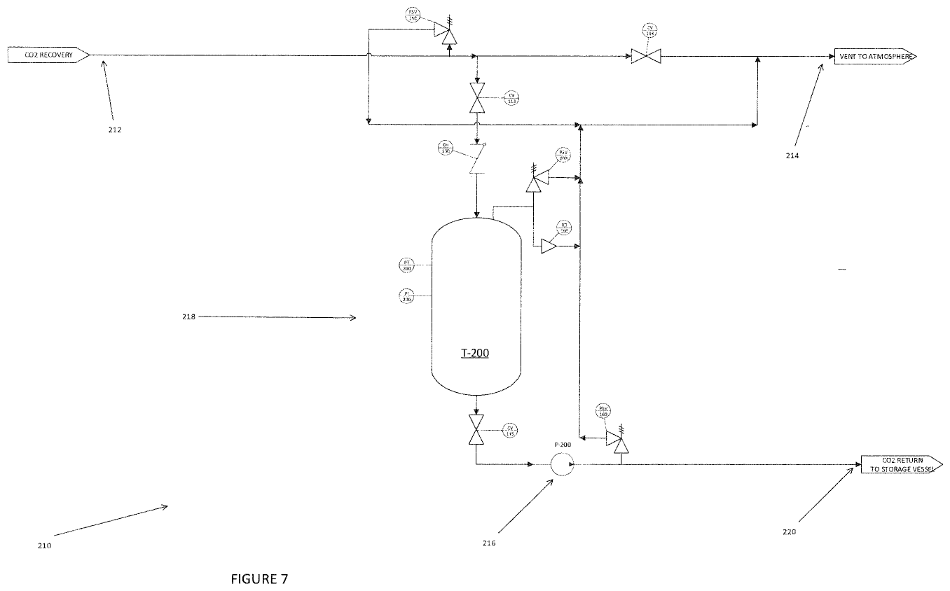

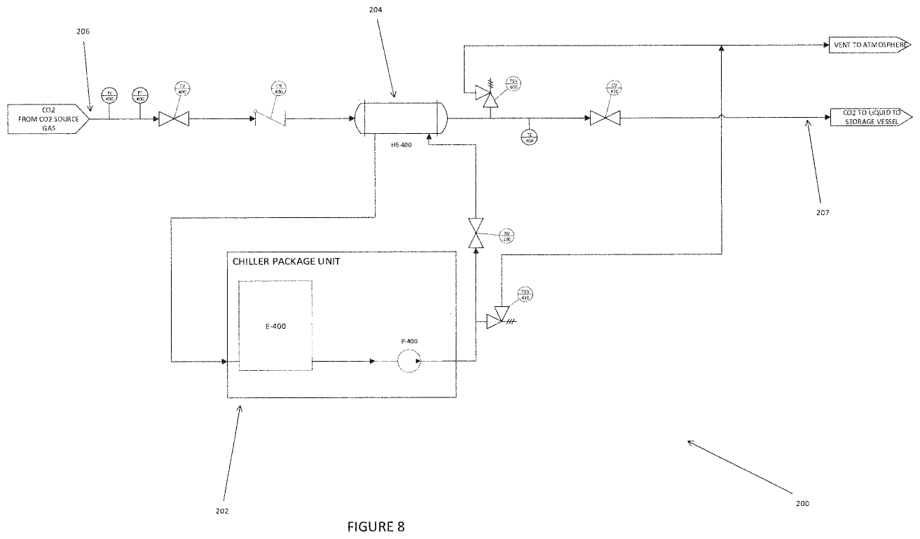

The gas flowing through the gas vent pathways delimited by the first (92) and second (98) gas vent lines and exiting through the gas vent exit (96) can be captured in a storage vessel (218) and circulated back into the first and second supply vessels (26, 28). FIG. 7 shows a gas capture and circulating device (210). The device, downstream of its gas entry port (212) and downstream of its storage vessel (218), has a pump (216) fluidly connected to the first and second supply vessels (26, 28). Gas exits the capture and circulating device through gas exit port (220) and flows to the supply vessels (26, 28) when the apparatus (18) is supplying fluid from the vessels to the downstream apparatus. Gas in excess of the storage vessels capacity can be vented to atmosphere from the circulating device through gas exit (214).

The first (50), second (76) and third (126) safety valves can be electronically actuated pneumatic valves or solenoid valves or combinations thereof. The valves can be connected to one or more processors. In general, the valves have an open and closed position. In general, the safety valves reside in an open position and reorient from the open to a closed position if the fluid transfer apparatus sensors detect a safety issue. A safety issue includes a sensor detecting an electrical failure or a sensor detecting a system air supply failure and/or a sensor detecting a carbon dioxide leak. A sensor detecting excessive temperature or pressure can also cause the safety valves to close.

The temperature sensor can be the manual temperature switch (146) which directly detects heat off the first (26) and second (28) supply vessels or heat of the CO₂ in each vessel. Each vessel can have its own switch (146). If the temperature of the CO₂ is too high in a supply vessel (26; 28) the switch (146) of that supply vessel actuates and breaks a circuit transmitting electricity to the heater (140) associated that vessel. The heater (140) for that vessel thus shuts down. Actuation of the switch causes signals to transmit to all three safety valves (50, 76, 126) to close. A processor or processors can, based on actuation of switch (146), receive signals, and based on the received signals transmit signals to the safety valves to close.

Another sensor includes the pressure transmitter (59) upstream, as measured along the first and second filling line fluid pathways delimited by the first (20) and second (22) filling lines, of the first safety valve (50). The pressure transmitter (59) interfaces with the first (20) and second (22) filling lines. The pressure transmitter, in electronic communication with one or more processors, sends its signals to the processor and the processor sends responsive signals to the safety valves (50, 76, 126), if the pressure transmitter (59) detects excessive pressure above a set pressure. The signals cause the safety valves to actuate the valves to close.

Another sensor includes the temperature element (144), which can be a thermo couple. The sensor can transmit signals based on the measured temperature which can cause the safety valves to close. Any sensor such as any pressure transmitter (59, 88), or any temperature element (144) can cause a shutdown of all safety valves if any sensor detects a value above a threshold, setpoint.

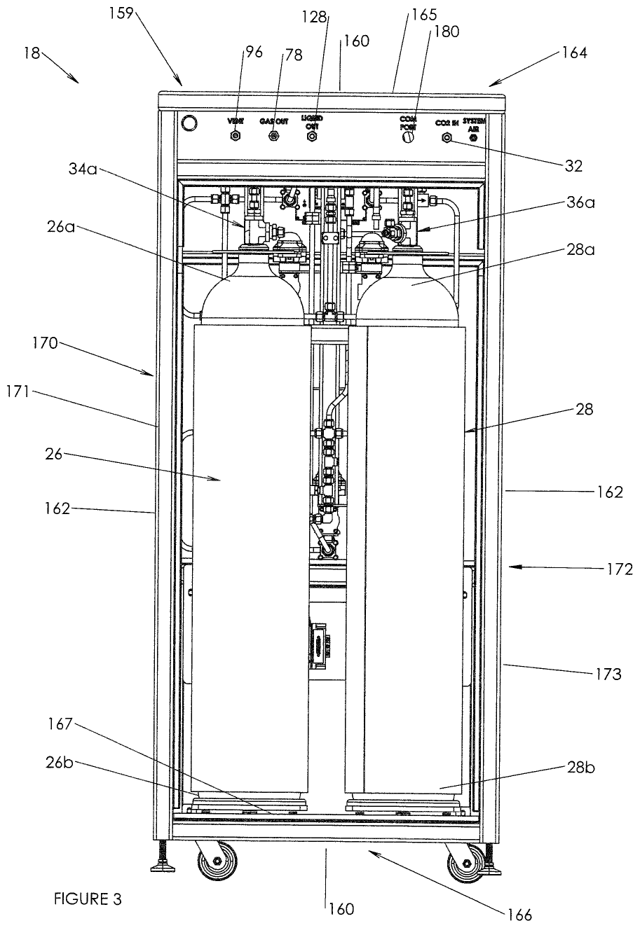

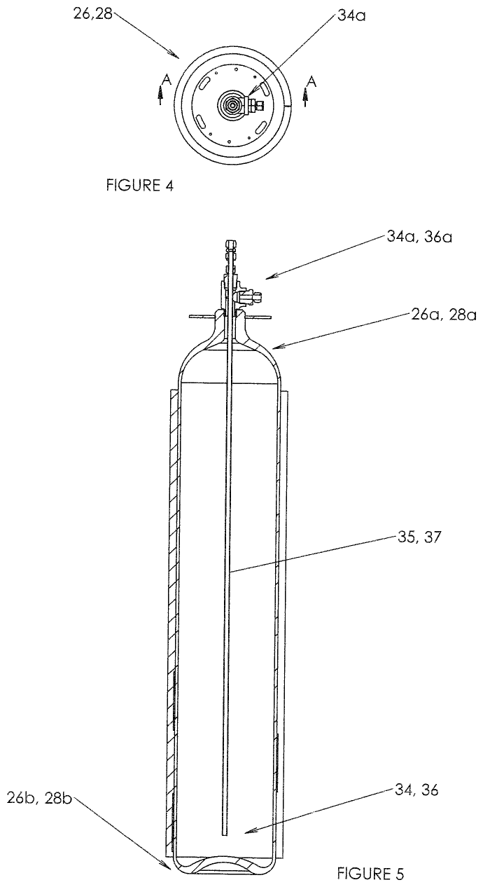

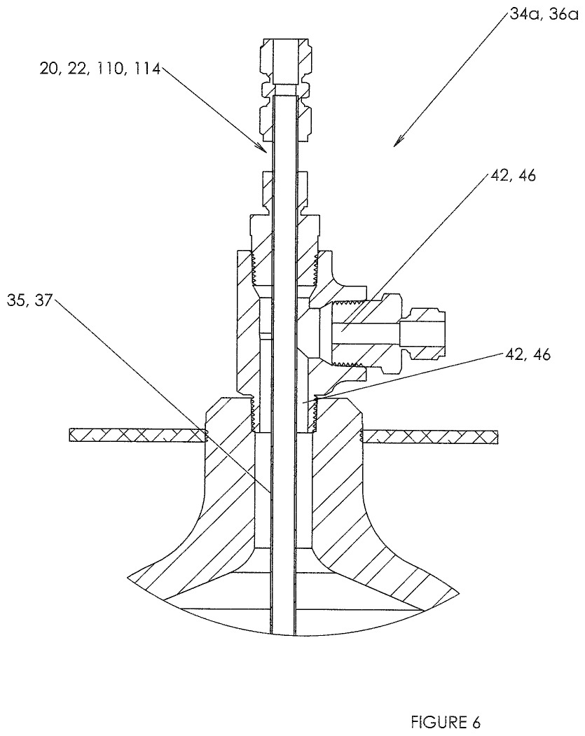

As shown in FIGS. 3 and 4, the apparatus creates a very small footprint on the floor or other support on which it sits. In connection with the small footprint, the apparatus has a major axis which extends along a first length measured from a first end (164) having a first end surface (165) to a second end (166) having a base surface (167). The apparatus has a minor axis which extends along a second length measured from a first side (170) having a first side surface (171) to a second side (172) having a second side surface (173). The first length is longer than the second length. The apparatus has an installed orientation wherein the second end resides proximate the support on which the device sits, and the first end resides distal the support on which the apparatus sits. The major axis perpendicular to a surface of the support on which the apparatus sits. The surface facing towards the second end and in the same direction as the base surface. The major axis perpendicular to the horizon. The minor axis parallel to the surface on which the support sits and parallel to the horizon. The footprint is the area of a smallest circle encircling the apparatus proximate the second end wherein the diameter of the circle is perpendicular to the major axis. The footprint can also be considered the area of a smallest circle encircling the device midway between the first and second ends wherein the dimeter is perpendicular to the major axis. The footprint can also be considered the area of a smallest circle encircling the device proximate the first end wherein the dimeter is perpendicular to the major axis. In the present example each of the above circles have a diameter ranging from 3.53 feet to 7 feet and more usually 4.24 feet. The footprint can also be the average area of the above circles or the smallest area delimited by one of the three circles. In the present example each of the circles have an area of about 14.4 feet square feet.

The apparatus has a communication port (180) which connects the apparatus (18) to the downstream apparatus by way of a data cable or the like. The connection allows the apparatus (18) to talk to the downstream apparatus.

The above description refers to pressures, weights and temperatures when setting forth how the features and components of the apparatus function. There are of course enumerable pressures, weights and temperatures over which the apparatus can function. By way of example, the apparatus can function over the pressures, temperatures and weights set forth in below scenarios 1 and 2.

### Scenario 1

### Bulk Storage Pressure: 300 psi

### Blow Down Pressure of First Supply Vessel: 200 psi

Setpoint Pressure of Fluid in First Supply Vessel after Heating: 1500 psi

### CO₂ State: Supercritical

### Fill Weight: 100 lbs

### Floor Weight: 33 lbs

### Max Temp: 180° F.

The apparatus (18) would start out by blowing down excess pressure in the first supply vessel (26) until the pressure drops below 200 psi. The apparatus (18) blows down the pressure by opening the first gas vent control valve (94). Once this pressure is achieved, the apparatus opens the first filling line control valve (65) allowing liquid CO₂ at 300 psi and −0° F. to flow from said bulk storage vessel (24) through the first filling line entry port (32) and flow through the first filling line (20) and through the first filling line exit port (34) and into the first supply vessel (26) until the fill weight of the fluid in the supply vessel (26) reaches 100 pounds. Once the fill is complete, the bulk storage vessel (24) is isolated from the process by the closing of the first filling line control valve (65). The vent control valve (94) also closes. The heater will then heat the CO₂ in the first supply vessel to a temperature of −100° F. which places the fluid in the first supply vessel (26) at a set point pressure of 1500 psi. Once the set point pressure has been reached, the system will then open the first gas supply line control valve (80) allowing the pressurized CO₂ in the supercritical phase to flow to the downstream apparatus such as processing equipment. As the CO₂ is taken from the first supply vessel to the apparatus (18), heat from the heater (140) will need to be continually added to maintain the setpoint pressure. Fluid will continue to flow out the first supply vessel (26) to the downstream apparatus until it reaches a floor weight of about 33 lbs. Once this floor has been reached, the apparatus will close the first gas supply line control valve (80). The apparatus will open the first gas vent control valve (94) and first filling line control valve (65) and start the filling process over again.

### Scenario 2

### Bulk Storage Pressure: 300 psi

### Blow Down Pressure of First Supply Vessel: 200 psi

Setpoint Pressure of Fluid in First Supply Vessel after Heating: 900 psi
CO₂ State: liquefied with a gas head

### Fill Weight: 100 lbs

### Floor Weight: 20 lbs

The apparatus (18) would start out by blowing down excess pressure in the first supply vessel (26) until the pressure drops below 200 psi. The apparatus (18) blows down the pressure by opening the first gas vent control valve (94). Once this pressure is achieved, the apparatus (18) opens the first filling line control valve (65) allowing liquid CO₂ at 300 psi and −0° F. to flow from the bulk storage vessel (24), through the first filling line entry port (32) and flow through the first filling line exit port (34) and into the first supply vessel (26) until the fill weight of the fluid in the supply vessel reaches 100 pounds. Once the fill is complete, the bulk storage vessel (24) is isolated from the process by the closing of the first filling line control valve (65). The vent control valve (94) also closes. The heater (140) will then heat the CO₂ in the first supply vessel to a temperature of 74° F. which places the fluid in the first supply vessel at a pressure of 900 psi. Once the set point pressure has been reached, the system will then open the first liquefied gas supply line control valve (116) allowing the liquefied CO₂ flow to the downstream apparatus such as processing equipment. As the CO₂ is taken from the first supply vessel (26), heat from the heater (140) will need to be continually added to maintain the setpoint pressure. Fluid will continue to flow out the first supply vessel (26) until it reaches a floor weight of about 20 lbs. Once this floor has been reached the apparatus will close the first liquefied gas supply line control valve (116). The apparatus will open the first gas vent control valve (94) and first filling line control valve (65) and start the filling process over again.

As can be easily understood from the foregoing, the basic concepts of the present invention may be embodied in a variety of ways. The invention involves numerous and varied embodiments of a fluid transfer apparatus and methods for making and using such a fluid transfer apparatus.

As such, the particular embodiments or elements of the invention disclosed by the description or shown in the figures or tables accompanying this application are not intended to be limiting, but rather exemplary of the numerous and varied embodiments generically encompassed by the invention or equivalents encompassed with respect to any particular element thereof. In addition, the specific description of a single embodiment or element of the invention may not explicitly describe all embodiments or elements possible; many alternatives are implicitly disclosed by the description and figures.

It should be understood that each element of an apparatus or each step of a method may be described by an apparatus term or method term. Such terms can be substituted where desired to make explicit the implicitly broad coverage to which this invention is entitled. As but one example, it should be understood that all steps of a method may be disclosed as an action, a means for taking that action, or as an element which causes that action. Similarly, each element of an apparatus may be disclosed as the physical element or the action which that physical element facilitates. As but one example, the disclosure of a “bulk storage vessel” should be understood to encompass disclosure of the act of “storing”—whether explicitly discussed or not—and, conversely, were there effectively disclosure of the act of “exiting” such a disclosure should be understood to encompass disclosure of an exit and even a “means for exiting”. Such alternative terms for each element or step are to be understood to be explicitly included in the description.

In addition, as to each term used it should be understood that unless its utilization in this application is inconsistent with such interpretation, common dictionary definitions should be understood to be included in the description for each term as contained in the Random House Webster's Unabridged Dictionary, second edition, each definition hereby incorporated by reference.

All numeric values herein are assumed to be modified by the term “about”, whether or not explicitly indicated. For the purposes of the present invention, ranges may be expressed as from “about” one particular value to “about” another particular value. When such a range is expressed, another embodiment includes from the one particular value to the other particular value. The recitation of numerical ranges by endpoints includes all the numeric values subsumed within that range. A numerical range of one to five includes for example the numeric values 1, 1.5, 2, 2.75, 3, 3.80, 4, 5, and so forth. It will be further understood that the endpoints of each of the ranges are significant both in relation to the other endpoint, and independently of the other endpoint. When a value is expressed as an approximation by use of the antecedent “about,” it will be understood that the particular value forms another embodiment. The term “about” generally refers to a range of numeric values that one of skill in the art would consider equivalent to the recited numeric value or having the same function or result. Similarly, the antecedent “substantially” means largely, but not wholly, the same form, manner or degree and the particular element will have a range of configurations as a person of ordinary skill in the art would consider as having the same function or result. When a particular element is expressed as an approximation by use of the antecedent “substantially,” it will be understood that the particular element forms another embodiment.

Moreover, for the purposes of the present invention, the term “a” or “an” entity refers to one or more of that entity unless otherwise limited. As such, the terms “a” or “an”, “one or more” and “at least one” can be used interchangeably herein.

Further, for the purposes of the present invention, the term “coupled” or derivatives thereof can mean indirectly coupled, coupled, directly coupled, connected, directly connected, or integrated with, depending upon the embodiment.

Additionally, for the purposes of the present invention, the term “integrated” when referring to two or more components means that the components (i) can be united to provide a one-piece construct, a monolithic construct, or a unified whole, or (ii) can be formed as a one-piece construct, a monolithic construct, or a unified whole. Said another way, the components can be integrally formed, meaning connected together so as to make up a single complete piece or unit, or so as to work together as a single complete piece or unit, and so as to be incapable of being easily dismantled without destroying the integrity of the piece or unit.

Thus, the applicant(s) should be understood to claim at least: i) each of the fluid transfer apparatuses herein disclosed and described, ii) the related methods disclosed and described, iii) similar, equivalent, and even implicit variations of each of these devices and methods, iv) those alternative embodiments which accomplish each of the functions shown, disclosed, or described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) methods and apparatuses substantially as described hereinbefore and with reference to any of the accompanying examples, x) the various combinations and permutations of each of the previous elements disclosed.

The claims set forth in this specification, if any, are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent application or continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon. The elements following an open transitional phrase such as “comprising” may in the alternative be claimed with a closed transitional phrase such as “consisting essentially of” or “consisting of” whether or not explicitly indicated the description portion of the specification.

Additionally, the claims set forth in this specification, if any, are further intended to describe the metes and bounds of a limited number of the preferred embodiments of the invention and are not to be construed as the broadest embodiment of the invention or a complete listing of embodiments of the invention that may be claimed. The applicant does not waive any right to develop further claims based upon the description set forth above as a part of any continuation, division, or continuation-in-part, or similar application.

1. A fluid transfer apparatus comprising:
a first fluid filling line having an entry port, control valve, and exit port, said first filling line delimiting a first filling line fluid pathway;
a first fluid supply line having an entry port, control valve, and exit port, said first fluid supply line selected from a group of supply lines consisting of a first gas supply line having an entry port, control valve, and exit port; a first liquefied gas supply line having an entry port, control valve, and exit port; and combinations thereof; said first supply line delimiting a first supply line fluid pathway;
a first gas vent line having an entry port, control valve, and exit port;
wherein when said fluid transfer apparatus resides in a first fluid filling state of operation, said first fluid filling line fluidly interconnects a bulk storage vessel to a first fluid supply vessel, said first filling line control valve resides in an open state; pressure at said filling line entry port at a pressure greater than a gas pressure of gas in said supply vessel;
wherein when said gas vent line control valve resides in an open state, said gas vent line entry port in fluid connection with said gas in said supply vessel;
wherein when said fluid transfer apparatus in a first supply vessel pressurizing state of operation, said first filling line control valve closed; said gas vent line control valve closed; a heater heating fluid in said first supply vessel, said fluid being heated in said gas state and a liquified gas state; said gas in said first fluid supply vessel brought to a higher pressure than the pressure at said first fluid filling line entry port during the first fluid filling state of operation; and
wherein when said fluid transfer apparatus in a first fluid supply state of operation;
said first fluid supply line interconnects said first fluid supply vessel to a downstream apparatus.

2. The fluid transfer apparatus of claim 1, wherein when said fluid transfer apparatus resides in said first fluid supplying state of operation, said apparatus further comprising:
a T coupling coupled to an end of the first fluid supply vessel, said T coupling comprising an entry port into said first fluid supply line when said first fluid supply line operates as gas supply line.

3. The fluid transfer apparatus of claim 1, wherein said first filling line comprising:
an extension, said extension extends into said first supply vessel when said fluid transfer apparatus resides in said first fluid filling state of operation.

4. The fluid transfer apparatus of claim 3, wherein said first fluid filling line further comprising:
a safety valve having an open and closed position.

5. The fluid transfer apparatus of claim 4, further comprising:
a pressure indicator fluidly connected to said first fluid filling line and upstream of said safety valve.

6. The fluid transfer apparatus of claim 5, wherein said first fluid filling line further comprises:
a check valve downstream of said safety valve.

7. The fluid transfer apparatus of claim 6, wherein said first fluid filling line further comprising:
a pressure relief valve downstream of said check valve.

8. The fluid transfer apparatus of claim 1, wherein said entry port of said first fluid supply line, when said first fluid supply line forms said first gas supply line, also forms said entry port of said first gas vent line.

9. The fluid transfer apparatus of claim 1, wherein when the first fluid supply line forms said first gas supply line, said apparatus further comprising a first liquefied gas supply line having an entry port, said entry port in fluid connection with said first fluid supply vessel.

10. The fluid transfer apparatus of claim 3, wherein when said first fluid supply line operates as said first liquefied gas supply line, said first liquefied gas line includes said extension extending in said first supply vessel when said fluid transfer apparatus in said first fluid supply state of operation.

11. The fluid transfer apparatus of claim 10, wherein when said first supply line operates as said first liquefied gas supply line, said apparatus further comprising:
a first gas supply line coupled to said first fluid supply vessel when said fluid transfer apparatus in said first fluid supply state of operation.

12. The fluid transfer apparatus of claim 1, wherein when said fluid transfer apparatus in said first fluid filling state of operation, said apparatus further comprising:
a second fluid supply vessel fluidly coupled to said downstream apparatus;
a second fluid supply line fluidly interconnecting said second fluid supply vessel to said downstream apparatus, said second fluid supply line including an entry port, control valve, and exit port said control valve open; and
wherein a portion of the first fluid supply line is coextensive with a portion of the second fluid supply line.

13. The fluid transfer apparatus of claim 12, wherein said portions of said first fluid supply line coextensive with said second fluid supply line include an intersection, a check valve downstream of the intersection, a pressure relief valve downstream of said check valve, and said fluid exit ports being a single fluid exit port.

14. The fluid transfer apparatus of claim 13, wherein said first fluid supply line and second fluid supply line are respectively a first and second gas fluid supply line, said fluid exit port being a gas exit port.

15. The fluid transfer apparatus of claim 13, wherein said first fluid supply line and second fluid supply line are respectively a first and second liquefied gas fluid supply line, said fluid exit port being a liquefied gas exit port.

16. The fluid transfer apparatus of claim 1, wherein when said fluid transfer apparatus in said first fluid supply state of operation, said apparatus further comprising:
a second fluid supply vessel fluidly coupled to said downstream apparatus;
a second fluid filling line interconnecting said second fluid supply vessel to said bulk storage vessel, said second fluid filling line including an entry port, control valve, and exit port; and
wherein a portion of the first fluid filling line is coextensive with a portion of the second fluid filling line.

17. The fluid transfer apparatus of claim 16 wherein said portions of said first fluid filling line coextensive with said second fluid filling line include said entry ports being a single entry port, a safety valve, and an intersection.

18. The fluid transfer apparatus of claim 16, said apparatus further comprising:
a second gas vent line fluidly connected to said second fluid supply vessel, said second gas vent line including an entry port, control valve, and exit port;
wherein a portion of the first gas vent is coextensive with a portion of the second gas vent;
said coextensive portions including said exit ports being a single exit port, an intersection, and a pressure relief valve.

19. A method, comprising:
relieving a gas phase of a fluid from a first supply vessel to achieve a first gas pressure in said first supply vessel less than a gas pressure of a gas phase of said fluid in a bulk storage vessel;
transferring said fluid from said bulk storage vessel to said first supply vessel based on a difference in said gas pressure of said fluid in said bulk storage vessel and said gas pressure of said fluid in said first supply vessel, said fluid transferred, residing in said tank in a liquefied gas state and a gas state;
venting said fluid transferred to said first supply vessel from said first supply vessel in a gas phase at least during some of the time while fluid transfers from the bulk storage vessel to the first supply vessel;
ceasing venting said fluid from said first supply vessel;
isolating said bulk storage vessel from said first supply vessel; and
heating said fluid transferred to said first supply vessel to a second gas pressure higher than said pressure in said bulk storage vessel and said first gas pressure.

20. The method of claim 19, wherein heating said fluid in said first supply vessel comprising actuation of one or more heating elements engaged to an external surface of said storage vessel.
